(19) United States
(12) Patent Application Publication
(10) Pub. No.: US 2026/0327365 A1
(43) Pub. Date: Oct. 22, 2026

(54) METHOD FOR PRODUCING ASA OR ABS GRAFT COPOLYMERS WITH REDUCED DISCOLORATION

(71) Applicant: INEOS STYROLUTION GROUP GMBH, Frankfurt am Main (DE)

(72) Inventors: Maren WISSING, Muenster (DE); Wolfgang FISCHER, Heidlberg (DE); Felix KLAUCK, Madrid (ES); Christian RUTHARD, Mainz (DE)

(21) Appl. No.: 18/993,900

(22) PCT Filed: Jul. 13, 2023
(86) PCT No.: PCT/EP2023/069473

§ 371 Date: Jan. 13, 2025

(30) Foreign Application Priority Data
Jul. 15, 2022 (EP) 22185159.5

(51) Int. Cl. C08F 265/06; C08F 271/00; C08J 3/00; C08J 3/14

(52) U.S. Cl. CPC C08F 265/06; C08F 271/00; C08J 3/005; C08J 3/14; C08J 2351/00; C08J 2451/00

(57) ABSTRACT

The invention relates to a method for producing at least one ASA or ABS graft copolymer B with reduced discoloration, including a single- or double-stage production of a latex of the graft copolymer B by adding and carrying out an emulsion polymerization of vinyl aromatic and nitrile monomers in the presence of an acrylate or diene graft base B1 in order to form a graft shell B2, wherein a part of the vinyl aromatic monomer is metered in immediately after the vinyl aromatic nitrile monomer has been completely added.

The present invention relates to a process for producing graft copolymers having reduced discoloration, especially reduced yellowing, based on acrylonitrile-styrene-acrylate (ASA) or acrylonitrile-butadiene-styrene (ABS) graft copolymers, and to graft copolymers obtained by this process. The invention further relates to a process for producing a thermoplastic molding compound, comprising ABS or ASA graft copolymers obtained by the process of the invention, and to molding compounds obtained thereby.

ABS copolymers and ASA copolymers have already been used for decades in large volumes as thermoplastic molding compounds for the production of shaped articles of various kinds. It is known that styrene-acrylonitrile (SAN) and/or α-methylstyrene-acrylonitrile (AMSAN) copolymers can be modified by incorporation of one or more graft rubbers (also called graft copolymers hereinafter), for example grafted polybutadiene rubbers or grafted crosslinked polyacrylates, in order to improve impact resistance. These impact-modified SAN molding compounds can be produced by polymerization of styrene and acrylonitrile in the presence of, for example, a polybutadiene rubber and/or by subsequent mixing of a graft copolymer with a separately produced styrene-acrylonitrile matrix.

The profiles of properties of the molding compounds and the shaped articles produced therefrom can be very different. Particularly important properties of ABS and ASA molding compounds are advantageous mechanical properties, such as high toughness and impact resistance, good processibility, relatively high thermal stability, and a light base color (low yellowness index), in order that the material can be colored in a broad color spectrum.

Typically, the graft rubber copolymers are produced by producing crosslinked polyacrylate latices or polybutadiene latices as graft bases by emulsion polymerization, and then producing one or more graft shells by grafting on a mixture of, for example, styrene and acrylonitrile and optionally further monomers by graft emulsion polymerization. After the emulsion polymerization, the graft copolymer latex is generally precipitated, separated from the suspension, washed and dried (e.g. WO 2015/078751).

WO 2015/000873 describes graft copolymer latices where the precipitation step is followed by a sintering step in which the precipitated graft copolymer latex, especially an ABS graft copolymer latex, is agglomerated to larger particles at a temperature of 100° to 125° C.

Processes for producing ASA or ABS graft copolymers comprising a precipitation step and a sintering step are also described in WO 2020/043690 and WO 2020/020869. In a first step, the graft copolymer latex is mixed with the precipitation solution at a temperature T1 (precipitation temperature) in the range from 30 to 80° C., and then, in a second step, the precipitation mixture is kept at a temperature T2 (sintering temperature) in the range from 70 to 140° C. for a period of preferably 2 to 90 minutes.

By way of example, the production of ASA graft copolymers with 1 or 2 graft shells is described. The latter are obtained by graft emulsion polymerization in 2 stages, where styrene is first grafted onto a crosslinked polybutylacrylate rubber latex and then a mixture of styrene and acrylonitrile is grafted onto said first graft shell. The end of addition of monomers is followed by further polymerization at 65° C. for 60 minutes. The resultant ASA graft copolymer latex (Dw 500 nm) is then precipitated with the aid of MgSO₄ at 60° C. or 70° C. and thereafter sintered at 92° C. or 130° C. for 5 minutes.

WO 2020/020831 likewise discloses ASA graft copolymers having a styrene-acrylonitrile copolymer graft shell consisting of two layers, where the first layer has been formed by emulsion polymerization of styrene onto a polyacrylate latex, and the second layer—obtained by emulsion polymerization of styrene and acrylonitrile—has been grafted onto the polystyrene-grafted latex. The resultant graft copolymers were worked up by precipitation at 88° C., briefly heating to 99° C., filtration, washing and drying.

It is disadvantageous that the graft copolymers obtained by the processes according to the prior art have discoloration after the sintering step, especially yellowish to reddish discoloration, i.e. a high yellowness index.

WO 03/010214 describes the production of ABS graft copolymers having low residual styrene and acrylonitrile monomer contents by emulsion polymerization, wherein a mixture of styrene and acrylonitrile is added to a diene rubber base and polymerized up to a conversion of 95%, and then a third monomer (boiling point <120° C.), preferably methyl methacrylate, is added and polymerized.

The temperatures in the polymerization, further polymerization and precipitation are max. 93° C. The precipitation is followed by isolation and drying. There is no sintering step.

Known ASA and ABS graft copolymers often have an excessively high residual acrylonitrile monomer content that does not meet the current market demands, since acrylonitrile is harmful to health and has an unpleasant odor.

It is an object of the present invention to provide a process for producing ASA or ABS graft copolymers by which it is possible to obtain ASA or ABS graft copolymers having a low residual acrylonitrile monomer content. Moreover, the ASA or ABS graft copolymers, after sintering, should have at least only slight discoloration, if any, and should thus have a white or virtually white color, i.e. a low yellowness index (YI).

It has now been found that, surprisingly, the residual acrylonitrile monomer content of ASA or ABS graft copolymers can be distinctly lowered, and less discolored graft rubbers are obtained after sintering, when, in the course of production of the graft shell, after simultaneous addition of vinylaromatic monomer and nitrile monomer, further vinylaromatic monomer is added, and the reaction mixture obtained, composed of graft rubber base and added monomers, is allowed to polymerize.

The invention provides a process for producing at least one graft copolymer B comprising (preferably consisting of):
B1: 40% to 90% by weight, preferably 45% to 85% by weight, more preferably 50% to 70% by weight, based on graft copolymer B, of at least one, preferably one, graft base B1, obtained by emulsion polymerization of:
   B11 50% to 100% by weight, preferably 80% to 100% by weight, more preferably 90% to 99.9% by weight, based on graft base B1, of at least one monomer B11 selected from C₁-C₈ alkyl (meth)acrylate, preferably n-butyl acrylate, and butadiene;
   B12 0% to 10% by weight, preferably 0% to 5% by weight, often 0.1% to 5% by weight, more preferably 0% to 2.5% by weight, often 1% to 2.5% by weight, based on graft base B1, of at least one polyfunctional crosslinking monomer B12, preferably selected from allyl (meth)acrylate, divinylbenzene, diallyl maleate, diallyl fumarate, diallyl phthalate, triallyl cyanurate, triallyl isocyanurate and dihydrodicyclopentadienyl acrylate (DCPA);
   B13 0% to 50% by weight, preferably 0% to 20% by weight, more preferably 0% to 10% by weight, based on graft base B1, of at least one further monomer B13 selected from styrene, alpha-methylstyrene, C₁-C₄-alkylstyrene, acrylonitrile, methacrylonitrile, isoprene, chloroprene, methyl methacrylate, alkylene glycol di(meth)acrylate and vinyl methyl ether;
where the sum total of B11, B12 and B13 is 100% by weight; and
B2: 10% to 60% by weight, preferably 15% to 55% by weight, more preferably 30% to 50% by weight, based on graft copolymer B, of at least one, preferably one or two, more preferably two, graft shell(s) B2 obtained—in the presence of the at least one graft base B1—by emulsion polymerization of:
   B21 50% to 100% by weight, preferably 50% to 95% by weight, more preferably 65% to 85% by weight, most preferably 70% to 85% by weight, based on graft shell B2, of at least one vinylaromatic monomer B21 selected from styrene and alpha-methylstyrene; and
   B22 0% to 50% by weight, preferably 5% to 50% by weight, more preferably 15% to 35% by weight, most preferably 15% to 30% by weight, based on graft shell B2, of at least one monomer B22 selected from acrylonitrile or mixtures of acrylonitrile and at least one further monomer selected from methacrylonitrile, acrylamide, vinyl methyl ether, anhydrides of unsaturated carboxylic acids (e.g. maleic anhydride or phthalic anhydride) and imides of unsaturated carboxylic acids (e.g. N-substituted maleimide such as N-cyclohexylmaleimide or N-phenylmaleimide);
where the sum total of B21 and B22 is 100% by weight; and
where at least one graft shell B2 is obtained by emulsion polymerization of 50% to 95% by weight, preferably 65% to 85% by weight, more preferably 70% to 85% by weight, of at least one monomer B21 and 5% to 50% by weight, preferably 15% to 35% by weight, more preferably 15% to 30% by weight, of at least one monomer B22;
where the sum total of the at least one graft base B1 and the at least one graft shell B2 is 100% by weight; and where
   the process comprises the following steps:
a) producing a latex of at least one graft copolymer B, comprising:
   a1) initially charging an aqueous latex comprising at least one, preferably one, graft base B1;
   a2) optionally producing a first graft shell B2 or B2′ by:
   a2-1) adding and emulsion polymerizing a first portion—based on the total amount B21—of the at least one monomer B21 or B21′, preferably styrene, to the graft base B1;
   a2-2) further polymerizing the latex obtained in a2-1);
   a3) producing a first graft shell B2 or, if steps a2-1) and a2-2 are conducted, producing a second graft shell B2 or B2″ by:
   a3-1) simultaneously adding and emulsion polymerizing a first or further portion of the at least one monomer B21 or B21″—based on the total amount B21—and the total amount of the at least one monomer B22 or B22″ to the latex from step a1) or a2-2);
   a3-2) immediately after the addition of the monomers in step a3-1) has ended, adding and emulsion polymerizing the residual portion of the at least one monomer B21 or B21″—based on the total amount B21—to the latex obtained in step a3-1);
   a3-3) further polymerizing the latex of graft copolymer B obtained in step 3-2), preferably for at least 15 minutes.

The process of the invention as described above may further comprise one or more of the following steps b) to g) (in the sequence specified):
b) precipitating the graft copolymer B latex obtained in step a) at a temperature of 30 to 95° C., preferably 40 to 90° C., more preferably 50 to 90° C., most preferably 60 to 88° C., by mixing the graft copolymer B latex with at least one precipitation solution PS to form a precipitation mixture;
c) sintering the precipitation mixture obtained in step b) at a temperature of 85 to 150° C., preferably 90 to 145° C., especially 90 to 140° C., most preferably 92 to 135° C., preferably for 15 to 90 minutes, more preferably 15 to 75 minutes, especially 20 to 60 minutes,
   where the temperature in step c) is at least 5° C., preferably at least 10° C., more preferably 15° C., higher than in step b); 25
d) optionally cooling the sintered precipitation mixture from step c), preferably to a temperature of 20 to 90° C.;
e) mechanically dewatering the sintered precipitation mixture obtained in step c) or d) to obtain a graft copolymer B having a water content of not more than 50% by weight, preferably not more than 40% by weight, more preferably 10% to 35% by weight, based in each case on the moist graft copolymer B;
f) optionally washing graft copolymer B obtained in step e);
g) optionally drying graft copolymer B obtained in step e) or f).

Preference is given to a process of the invention as described above, comprising steps a), b), c) and e), and optionally steps d), f) and/or g).

A ‘latex’ means a polymer dispersion, i.e. a mixture of polymer particles and an aqueous liquid.

### Graft Copolymer B

Graft copolymer B is preferably selected from ASA graft copolymers and ABS graft copolymers; particular preference is given to ASA graft copolymers.

ASA graft copolymers typically contain, as graft base B1, a crosslinked polyalkyl (meth)acrylate rubber, especially a crosslinked polybutylacrylate graft base B1.

ABS graft copolymers typically contain, as graft base B1, one or more polybutadiene rubbers and/or one or more styrene-butadiene rubbers.

Typically, graft base B1 consists of a polymer, preferably an at least partly crosslinked polymer, having a glass transition temperature (Tg) below 0° C., preferably below-20° C., more preferably below-40° C., with measurement of glass transition temperature T_{g} by dynamic-mechanical analysis (DMA) using a frequency of 1 Hz.

The at least one graft shell B2 typically consists of monomers that copolymerize to give a polymer having a glass transition temperature of more than +20° C., preferably more than +60° C.

Preferred monomers of graft shell B2 (monomers B21 and B22) are styrene and/or (alpha)-methylstyrene and (meth)acrylonitrile, especially styrene and acrylonitrile, and optionally methyl (meth)acrylate, ethyl acrylate, N-phenylmaleimide and maleic anhydride.

Preferred monomers B11 for production of graft base B1 are butadiene, alkyl acrylates and/or alkyl methacrylate (also referred to as alkyl (meth)acrylates) having 1 to 8, preferably 4 to 8, carbon atoms in the alkyl group.

Monomer B11 is preferably at least one monomer selected from C₄-C₈-alkyl acrylates, preferably selected from butyl acrylate, ethylhexyl acrylate and cyclohexyl acrylate.

Monomers B11 used are frequently n-butyl acrylate and/or 2-ethylhexyl acrylate; particular preference is given to n-butyl acrylate alone or in a mixture with other monomers B11.

In order to achieve crosslinking of the C₁-C₈-alkyl (meth)acrylate monomers B11 and hence crosslinking of graft base B1, monomers B11 are polymerized in the presence of 0.1% to 10% by weight, preferably 0.1% to 5% by weight, more preferably 0.5% to 4% by weight, even more preferably 1% to 3% by weight, especially 1% to 2.5% by weight, based on graft base B1, of one or more polyfunctional crosslinking monomer(s) B12.

Suitable monomers B12 are especially polyfunctional crosslinking monomers that can be copolymerized with the monomers mentioned, especially B11 and B13.

Suitable polyfunctional crosslinking monomers B12 contain two or more, preferably two or three, more preferably exactly two, ethylenic double bonds that are preferably not 1,3-conjugated.

Examples of suitable polyfunctional crosslinking monomers B12 are allyl (meth)acrylate, divinylbenzene, diallyl esters of carboxylic acids, for example diallyl maleate, diallyl fumarate and diallyl phthalate. The acrylic ester of tricyclodecenyl alcohol (tricyclodecenyl acrylate, dihydrodicyclopentadienyl acrylate, DCPA)—as described in DE-A 1 260 135—is also a preferred polyfunctional crosslinking monomer B12.

In particular, the polyfunctional crosslinking monomer B12 (which is preferably used for crosslinking of polyalkyl (meth)acrylate rubber) is at least one monomer selected from allyl (meth)acrylate (AMA), divinylbenzene, diallyl maleate, diallyl fumarate, diallyl phthalate, triallyl cyanurate, triallyl isocyanurate and dihydrodicyclopentadienyl acrylate (DCPA), preferably allyl (meth)acrylate, divinylbenzene, diallyl maleate, diallyl fumarate, diallyl phthalate and DCPA, preferably from allyl (meth)acrylate and DCPA.

In a preferred embodiment, 1% to 2.5% by weight, preferably 1.5% to 2.2% by weight, based on graft base B1, of dihydrodicyclopentadienyl acrylate (DCPA) is used alone or in a mixture with at least one further monomer B12 among those mentioned above, especially in a mixture with allyl (meth)acrylate, as monomer B12.

In addition, the at least one graft base B1 may optionally contain one or more copolymerizable, monoethylenically unsaturated monomers B13 other than B11 and B12.

Monomers B13 may be selected, for example, from styrene, alpha-methylstyrene, C₁-C₄-alkylstyrene, acrylonitrile, methacrylonitrile, isoprene, chloroprene, methyl methacrylate, alkylene glycol di(meth)acrylate and vinyl methyl ether.

The further monomer B13 is preferably at least one monomer selected from styrene, (alpha)-methylstyrene, acrylonitrile, methacrylonitrile, methyl (meth)acrylate, isoprene, chloroprene and C₁-C₄-alkylstyrene.

In a preferred embodiment, the vinylaromatic monomer is styrene and/or (alpha)-methylstyrene, and monomer B22 is acrylonitrile or a mixture of acrylonitrile and at least one monomer selected from methacrylonitrile, acrylamide, vinyl methyl ether, maleic anhydride, phthalic anhydride, N-cyclohexylmaleimide and N-phenylmaleimide. If B22 is a mixture of acrylonitrile and at least one monomer selected from methacrylonitrile, acrylamide, vinyl methyl ether, maleic anhydride, phthalic anhydride, N-cyclohexylmaleimide and N-phenylmaleimide, the proportion of acrylonitrile, based on the total amount B22, is at least 50% by weight, preferably at least 80% by weight, more preferably at least 90% by weight.

Particular preference is given to using acrylonitrile alone as monomer B22.

Monomers B21 and B22 that are used for emulsion polymerization of graft copolymer B are more preferably mixtures of styrene and acrylonitrile having a weight ratio of styrene to acrylonitrile in the range from 95:5 to 50:50, preferably in the range from 90:10 to 65:35, more preferably in the range from 85:15 to 70:30.

In a preferred embodiment, the at least one graft base B1 is obtained by emulsion polymerization of:
B11: 80% to 99.9% by weight, preferably 90% to 99.5% by weight, more preferably 90% to 99.0% by weight, based on graft base B1, of at least one C₁-C₈-alkyl (meth)acrylate, preferably n-butyl acrylate and/or 2-ethylhexyl acrylate, as monomer B11;
B12:0.1% to 10% by weight, preferably 0.5% to 4% by weight, more preferably 1% to 2.5% by weight, based on graft base B1, of at least one polyfunctional crosslinking monomer B12; preferably selected from allyl (meth)acrylate, divinylbenzene, diallyl maleate, diallyl fumarate, diallyl phthalate, triallyl cyanurate, triallyl isocyanurate and dihydrodicyclopentadienyl acrylate (DCPA);
B13: 0% to 19.9% by weight, preferably 0% to 9.5% by weight, more preferably 0% to 9.0% by weight, based on graft base B1, of at least one further monomer, preferably selected from styrene, alpha-methylstyrene, C₁-C₄-alkylstyrene, acrylonitrile, methacrylonitrile, isoprene, chloroprene, methyl methacrylate, alkylene glycol di(meth)acrylate and vinyl methyl ether;
   where the sum total of B11, B12 and B13 is 100% by weight.

In a further preferred embodiment, the at least one graft base B1 is obtained by emulsion polymerization of:
B11: 90% to 99.9% by weight, preferably 97% to 99.5% by weight, more preferably 97.5% to 99% by weight, based on graft base B1, of at least one C₁-C₈-alkyl (meth)acrylate, preferably at least one C₄-C₈-alkyl (meth)acrylate, more preferably n-butyl acrylate and/or 2-ethylhexyl acrylate, most preferably n-butyl acrylate, as monomer B11; and
B12:0.1% to 10% by weight, preferably 0.5% to 3% by weight, more preferably 1% to 2.5% by weight, based on graft base B1, of at least one polyfunctional crosslinking monomer B12; selected from allyl (meth)acrylate, divinylbenzene, diallyl maleate, diallyl fumarate, diallyl phthalate and dihydrodicyclopentadienyl acrylate (DCPA), especially from allyl (meth)acrylate and/or dihydrodicyclopentadienyl acrylate (DCPA);
   where the sum total of B11 and B12 is 100% by weight (based on all monomers of graft base B1).

In particular, further suitable compositions of graft base B1, containing monomers B11, B12 and optionally B13, and the general process for production thereof, are described, for example, in DE-A 28 26 925, DE-A 31 49 358 and DE-A 34 14 118.

In a preferred embodiment, the at least one graft shell B2 is obtained by emulsion polymerization in the presence of the at least one graft base B1 from:
B21: 50% to 95% by weight, preferably 65% to 90% by weight, more preferably 70% to 85% by weight, based on graft shell B2, of at least one vinylaromatic monomer B21, where monomer B21 is selected from styrene and (alpha)-methylstyrene, especially styrene, and
B22: 5% to 50% by weight, preferably 10% to 35% by weight, more preferably 15% to 30% by weight, based on graft shell B2, of at least one ethylenically unsaturated monomer B22, where monomer B22 is selected from acrylonitrile or mixtures of acrylonitrile and at least one further monomer selected from methacrylonitrile, acrylamide, vinyl methyl ether, anhydrides of unsaturated carboxylic acids (e.g. maleic anhydride, phthalic anhydride) and imides of unsaturated carboxylic acids (e.g. N-substituted maleimide such as N-cyclohexylmaleimide and N-phenylmaleimide), preferably selected from acrylonitrile or mixtures of acrylonitrile and methacrylonitrile.

In particular, graft copolymer B contains a graft base B1, preferably a crosslinked polyalkyl (meth)acrylate rubber as described above, and one or more graft shell(s) B2, especially one or two graft shells B2 that differ in the selection and amount of monomers B21 and B22 and are obtained by stepwise graft emulsion polymerization of monomers B21 and/or B22 in the presence of graft base B1 or in the presence of already grafted graft base based on B1.

In a preferred embodiment, graft copolymer B contains at least one graft base B1, preferably a crosslinked polybutylacrylate rubber as described above, and exactly one graft shell B2 obtained by emulsion polymerization of monomers B21 and B22 as described above, especially styrene and acrylonitrile, in the presence of graft base B1 (one-state grafting).

In a further preferred embodiment, graft copolymer B contains at least one graft base B1, preferably a crosslinked polybutylacrylate rubber as described above, and two different graft shells B2, referred to as graft shells B2′ and B2″, where B2′ is obtained by emulsion polymerization of monomer B21 (referred to as B21′), especially styrene, in the presence of graft base B1, and graft shell B2″ is obtained by subsequent emulsion polymerization of monomers B21 and B22 (referred to as B21″ and B22″) as described above, especially styrene and acrylonitrile, in the presence of graft base B1 that has been grafted with B2′ (two-stage grafting).

In a preferred embodiment (one-stage grafting), graft copolymer B contains:
B1: 50% to 70% by weight, preferably 55% to 65% by weight, more preferably 58% to 65% by weight, based on graft copolymer B, of at least one, preferably one, graft base B1 as described above, where the at least one graft base B1 preferably has a particle size (especially average particle diameter Dᵥ) in the range from 50 to 190 nm, preferably 60 to 150 nm, more preferably 60 to 100 nm;
B2: 30% to 50% by weight, preferably 35% to 45% by weight, more preferably 35% to 42% by weight, based on graft copolymer B, of a graft shell B2 obtained by emulsion polymerization, in the presence of at least one graft base B1, of:
   B21: 50% to 95% by weight, preferably 65% to 85% by weight, more preferably 70% to 85% by weight, based on graft shell B2, of at least one vinylaromatic monomer B21, where monomer B21 is selected from styrene and (alpha)-methylstyrene, especially styrene; and
   B22: 5% to 50% by weight, preferably 15% to 35% by weight, more preferably 15% to 30% by weight, based on graft shell B2, of at least one ethylenically unsaturated monomer B22, where monomer B22 is selected from acrylonitrile or mixtures of acrylonitrile and at least one further monomer selected from methacrylonitrile, acrylamide, vinyl methyl ether, anhydrides of unsaturated carboxylic acids (e.g. maleic anhydride, phthalic anhydride) and imides of unsaturated carboxylic acids (e.g. N-substituted maleimide such as N-cyclohexylmaleimide and N-phenylmaleimide), preferably selected from acrylonitrile or mixtures of acrylonitrile and methacrylonitrile;
      where the sum total of graft base B1 and graft shell B2 is 100% by weight, and where the latex of graft copolymer B obtained in step a) has a particle size (especially average particle diameter Dᵥ) in the range from 60 to 200 nm, preferably from 80 to 150 nm.

In a further embodiment, in the one-stage grafting described above, graft base B1, which preferably has a particle size (especially average particle diameter Dv) in the range from 80 to 150 nm, can be agglomerated by known agglomeration methods (e.g. WO 2012/022710 and WO 2014/170406 or WO 2014/170406). The agglomerated graft base B1 is then grafted as described above with a graft shell B2, where the latex obtained in step a) contains graft copolymers B having particle sizes (especially average particle diameter Dᵥ) in the range from 200 to 600 nm, preferably 250 to 500 nm, more preferably 300 to 400 nm. The latex obtained by means of an agglomerated graft base B1 is often bimodal and often has bimodal particle size distributions having particle sizes (especially average particle diameter Dv) in the range from 60 to 200 nm, often 60 to 150 nm, and 300 to 600 nm.

Typically, the particle size of latices of graft copolymer B may be reported as the volume-average particle diameter Dv value. The volume-average particle diameter Dv (or the average particle diameter according to De Broucker), also referred to as average particle diameter Dᵥ, is an average parameter based on the unit volume of the particles. For example, the volume-average particle diameter Dv can be determined by light scattering (laser diffraction) (for example with an instrument from Beckman Coulter).

In addition, the particle size can be reported as the median particle size D₅₀. The median particle diameter D₅₀ is the value on the particle size distribution curve at which 50% by volume of the particles (e.g. polyacrylate latex particles) have a diameter less than the D₅₀ value, and the other 50% by volume a diameter greater than the D₅₀ value. In a similar manner, for example, the Doo value indicates the particle diameter at which 90% by volume of all particles have a smaller diameter.

According to the present invention, the particle size mentioned in connection with the graft copolymer B preferably means the volume-average particle diameter Dv that has been determined by light scattering.

In a further preferred embodiment (two-stage grafting B2′ and B2″), graft copolymer B contains:
B1: 50% to 70% by weight, preferably 55% to 65% by weight, based on graft copolymer B, of at least one, preferably exactly one, graft base B1 as described above, where the at least one graft base B1 preferably has a particle size (especially average particle diameter Dv) in the range from 200 to 700 nm, preferably 300 to 600 nm, more preferably 350 to 550 nm;
B2′: 5% to 25% by weight, preferably 5% to 20% by weight, more preferably 5% to 15% by weight, based on graft copolymer B, of at least one graft shell B2′ which is obtained by emulsion polymerization, in the presence of graft base B1, of:
   B21′ 100% by weight, based on graft shell B2′, of at least one vinylaromatic monomer B21′ selected from styrene and (alpha)-methylstyrene, especially styrene; and
B2″: 20% to 40% by weight, preferably 20% to 35% by weight, based on graft copolymer B, of at least one graft shell B2″ which is obtained by emulsion polymerization, in the presence of graft base B1 grafted with B2′, of:
   B21″: 50% to 95% by weight, preferably 65% to 90% by weight, more preferably 70% to 85% by weight, based on graft shell B2″, of at least one vinylaromatic monomer B21″ selected from styrene and (alpha)-methylstyrene, especially styrene; and
   B22″: 5% to 50% by weight, preferably 10% to 35% by weight, more preferably 15% to 30% by weight, based on graft shell B2″, of at least one monomer B22″ selected from acrylonitrile or mixtures of acrylonitrile and at least one further monomer selected from methacrylonitrile, acrylamide, vinyl methyl ether, anhydrides of unsaturated carboxylic acids (e.g. maleic anhydride, phthalic anhydride) and imides of unsaturated carboxylic acids (e.g. N-substituted maleimide such as N-cyclohexylmaleimide and N-phenylmaleimide), preferably selected from acrylonitrile or mixtures of acrylonitrile and methacrylonitrile;
where the sum total of graft base B1, graft shell B2′ and graft shell B2″ is 100% by weight, and where the latex of graft copolymer B obtained in step a) has a particle size (especially average particle diameter Dv) in the range from 300 to 800 nm, preferably 350 to 700 nm.

In a further embodiment, graft copolymer B is a mixture of the above-described embodiments of one-stage graft copolymer B and two-stage graft copolymer B (including graft B2′ and B2″).

More preferably, monomers B21, B21′ and B21″ are styrene or mixtures of styrene and alpha-methylstyrene. The proportion of styrene, based on the total amount of B21 (or B21′ and B21″), is preferably at least 50% by weight, more preferably at least 80% by weight, most preferably at least 90% by weight.

Monomers B22 and B22″ are more preferably acrylonitrile or mixtures of acrylonitrile and at least one further monomer selected from methacrylonitrile, maleic anhydride, N-cyclohexylmaleimide, N-phenylmaleimide, more preferably acrylonitrile or mixtures of acrylonitrile and at least one further monomer selected from methacrylonitrile and maleic anhydride. In the aforementioned mixtures of acrylonitrile, the proportion of acrylonitrile, based on the total amount of monomers B22 or B22″, is at least 50% by weight, preferably at least 80% by weight, more preferably 90% by weight.

In a particularly preferred embodiment of the invention, monomers B21, B21′ and B21″ are styrene, and monomers B22 and B22″ are acrylonitrile.

In another embodiment, graft copolymer B may be an ABS graft copolymer containing:
B1: 40% to 80% by weight, preferably 45% to 70% by weight, more preferably 45% to 65% by weight, based on graft copolymer B, of at least one graft base B1 obtained by emulsion polymerization of butadiene as monomer B1; and
B2: 20% to 60% by weight, preferably 30% to 55% by weight, more preferably 35% to 55% by weight, based on graft copolymer B, of at least one graft shell B2 as described above, preferably obtained by emulsion polymerization of 65% to 85% by weight, based on graft shell B2, of styrene as monomer B21 and 15% to 35% by weight, based on graft shell B2, of acrylonitrile as monomer B22, in the presence of the at least one graft base B1;
   where the sum total of graft base B1 and graft shell B2 is 100% by weight; and where the latex of the ABS graft copolymer B has a particle size (especially average particle diameter Dv) in the range from 100 to 500 nm.

In a further embodiment of the invention, the process of the invention comprises the synthesis of at least two, preferably two, three or four, different graft copolymers B, where graft copolymers B (e.g. graft copolymers B-I and B-II) differ in terms of their particle size.

Graft copolymer B, in the aforementioned embodiment, especially comprises at least two graft copolymers B-I and B-II, preferably based on crosslinked C₁-C₈-alkyl (meth)acrylate graft bases B1 as described above, where:
graft copolymer B-I (fine ASA rubber) has a particle size (especially average particle diameter Dv) in the range from 60 to 200 nm, preferably from 80 to 150 nm, and
graft copolymer B-II (coarse ASA rubber) has a particle size (average particle diameter Dv) in the range from 300 to 800 nm, preferably 350 to 700 nm.

Graft copolymer B-I (fine ASA rubber) is preferably obtained by emulsion polymerization of monomers B21 and B22 as described above, especially of styrene as B21 and acrylonitrile as B22, in the presence of graft base B1 that has been produced beforehand as described above, as an example of a one-stage graft copolymer B.

The graft copolymer B-II (coarse ASA rubber) is preferably to have a narrow particle size distribution, where the particle size distribution Q=(D₉₀−D₁₀)/D₅₀ is less than 0.3, preferably less than 0.2.

In a further preferred embodiment, graft copolymer B is a graft copolymer which has a core-shell structure and has been obtained by emulsion polymerization, comprising an inner core BK1 and three layers BK2, BH1 and BH2, in the sequence BK1, BK2, BH1, BH2 from the inside outward (for example as described in WO 2020/020834 A1). In the above-described graft copolymer B with a core-shell structure, the above-described graft base B1 comprises an inner core BK1 and an outer core shell BK2, and the graft shell B2 or B2′ and B2″ comprises the layers BH1 and BH2.

In a further preferred embodiment, graft copolymer B is a graft copolymer which has a core-shell structure and has been obtained by emulsion polymerization, comprising an inner core BS and four layers BK1, BK2, BH1 and BH2, in the sequence BS, BK1, BK2, BH1, BH2 from the inside outward.

In the above-described graft copolymer B with a core-shell structure, the above-described graft base B1 comprises an inner core BS, a first core shell BK1 and a second (outer) core shell BK2, and the graft shell B2 or B2′ and B2″ comprises the layers BH1 and BH2.

It is often the case that such graft copolymers B having a core-shell structure are composed of:
BS: 0% to 5% by weight of an inner core BS consisting of at least one copolymer of:
   BK21:95.0% to 99.0% by weight of at least one C2-C8-alkyl acrylate;
   BK22:1.0% to 5.0% by weight of one or more bi- or polyfunctional crosslinking monomers;
BK1: 0% to 19% by weight of an inner core BK1, or—if BS is present—a core shell BK1, consisting of at least one copolymer of:
   BK11:95.0 to 99.9% by weight of at least one vinylaromatic monomer and
   BK12:0.1% to 5.0% by weight of at least one bi- or polyfunctional crosslinking monomer;
BK2: 40% to 61% by weight of a core shell BK2 consisting of at least one copolymer of:
   BK21:95.0% to 99.0% by weight of at least one C2-C8-alkyl acrylate;
   BK22:1.0% to 5.0% by weight of one or more bi- or polyfunctional crosslinking monomers;
BH1: 1% to 19% by weight of a first graft shell layer BH1, consisting of at least one vinylaromatic polymer; and
BH2: 21% to 39% by weight of a second graft shell layer BH2, consisting of at least one copolymer containing at least one vinylaromatic monomer BH21 and at least one nitrile monomer BH22;
where the sum total of BS, BK1, BK2, BH1 and BH2 is 100% by weight; and
where the average particle diameter Dy of graft copolymer B is in the range from 300 to 600 nm.

Suitable crosslinked C₁-C₈-alkyl (meth)acrylate polymer graft bases B1 of graft copolymer B-II (referred to as B1-II) may be produced by known methods of production of coarse dispersions, appropriately by seed polymerization, as described in DE 1 911 882 for production of ASA polymers.

According to this method, a finely divided, crosslinked acrylate latex or a finely divided, crosslinked polystyrene latex having a particle size (especially average particle diameter D_{w}) of 50 to 180 nm, preferably 50 to 120 nm, is used as seed latex. The seed latex which is obtained by emulsion polymerization of C₁-C₈-alkyl (meth)acrylates and crosslinking monomers or by emulsion polymerization of styrene and crosslinking monomers (see, for example, BK1 as described above) is subjected to a further polymerization reaction. In particular, the reaction conditions are adjusted such that only further growth of the present seed latex particles is enabled without forming new latex particles (described in Journal of Applied Polymer Science, vol. 9 (1965), pages 2929 to 2938). Normally, an initiator is used in this method.

By varying the ratio of seed latex to monomers, it is possible to adjust the particle size of the resulting graft copolymer B-II (coarse rubber).

Graft copolymer B-II is preferably obtained by emulsion polymerization of monomers B21 and B22 as described above, especially styrene or α-methylstyrene as B21 and acrylonitrile as B22, in the presence of the previously produced graft base B1-II.

Preferably, the above-described graft copolymers B-I and B-II, in steps a) to c), optionally d), and e), and optionally f) and g), are produced separately, precipitated, sintered, optionally cooled, dewatered, and optionally washed and dried.

It is also possible to mix graft copolymer latices B-I and B-II after separate production thereof in step a), and to precipitate them together in step b). Subsequent steps such as sintering in step c), cooling in step d), dewatering in step e), washing in step f) and drying in step g) can be conducted as described.

The weight ratio of graft copolymers B-I and B-II can be varied in wide ranges. Preferably, graft copolymer B is a mixture of graft copolymers B-I and B-II, where the weight ratio of B-I:B-II is from 90:10 to 10:90, preferably 80:20 to 20:80.

Known agglomeration methods can also be used to obtain graft copolymers B having different particle sizes, in particular bimodal particle size distributions of 60 to 200 nm and 300 to 600 nm.

Graft copolymers having large and small particles are described, for example, in DE-A 36 15 607.

In addition, it is possible to use graft copolymers B having two or more different graft shells B2 as described above. Further graft copolymers having multilayer graft shells are described for example in EP-A 0111260 and WO 2015/078751.

Step a)—Production of Graft Copolymer B by Emulsion Polymerization

The production of a latex of at least one graft copolymer B in step a) of the process of the invention comprises:
a1) initially charging an aqueous latex comprising at least one, preferably one, graft base B1;
a2) optionally producing a first graft shell B2 or B2′ by:
   a2-1) adding and emulsion polymerizing a first portion—based on the total amount B21—of the at least one monomer B21 or B21′, preferably styrene, to the graft base B1;
   a2-2) further polymerizing the latex obtained in a2-1);
a3) producing a first graft shell B2 or—if steps a2-1) and a2-2 are conducted—producing a second graft shell B2 or B2″ by:
   a3-1) simultaneously adding and emulsion polymerizing a first or further portion of the at least one monomer B21 or B21″—based on the total amount B21—and the total amount of the at least one monomer B22 or B22″ to the latex from step a1) or a2-2);
   a3-2) immediately after the addition of the monomers in step a3-1) has ended, adding and emulsion polymerizing the residual portion of the at least one monomer B21 or B21″—based on the total amount B21—to the latex obtained in step a3-1);
   a3-3) further polymerizing the latex of graft copolymer B obtained in step 3-2).

Typically, graft copolymer B is produced in the form of a latex (rubber) by emulsion polymerization in step a), where one or more graft base(s) B1 are first obtained by emulsion polymerization of monomers B11, B12 and optionally B13 as described, and then one or more graft shell(s) B2 are obtained by emulsion polymerization of monomers B21 and B22 as described in the presence of one or more of the graft bases B1.

Preferably, the latex of graft copolymer B is polymerized by aqueous free-radical emulsion polymerization. The reaction is typically initiated by means of water-soluble or oil-soluble free-radical polymerization initiators, for example inorganic or organic peroxides, such as peroxodisulfate or benzoyl peroxide, or with the aid of redox initiator systems (see WO 2002/10222, DE-A 28 26 925, and EP-A 022 200). Preferably, an inorganic peroxide salt, especially an inorganic peroxodisulfate salt, preferably sodium peroxodisulfate and/or potassium peroxodisulfate, is used in the emulsion polymerization of graft copolymer B.

Emulsifiers present in the production of graft base B1 and/or in the emulsion polymerization for production of the at least one graft copolymer B may be customary anionic emulsifiers. Emulsifiers used are preferably: alkylsulfates, alkylsulfonates, alkylsulfonic acids, arylsulfonates, soaps of saturated or unsaturated fatty acids, and alkali-disproportionated or hydrogenated abietic acids or tall oil acids or mixtures thereof. Butadiene-based graft bases are preferably produced using emulsifiers having carboxyl groups (e.g. disproportionated abietic acid, salts of C₁₀-C₁₈ fatty acids). Further preferably, for butadiene-based graft bases, emulsifiers used may be alkali metal soaps of sodium and potassium salts of disproportionated and/or dehydrogenated and/or hydrogenated and/or partly hydrogenated resins (rosin) having a content of at least 30% by weight of dehydroabietic acid and having a content of not more than 1% by weight of abietic acid.

Emulsifiers used for production of graft bases based on C₁-C₈-alkyl (meth)acrylates are preferably C₁₀-C₂₀-alkylsulfonic acids and/or C₁₀-C₂₀-alkylsulfonates, for example a C₁₂-C₁₈-alkylsulfonic acid.

In addition, salts, acids and bases may be used in the emulsion polymerization of graft base B1 and of graft shell B2, especially for adjustment of pH or for buffering of the reaction mixture.

For example, it is possible to use sulfuric acid, phosphoric acid, solutions of sodium hydroxide, potassium hydroxide, sodium salts and potassium salts of carbonates, bicarbonates, sulfates and/or phosphates (e.g. tetrasodium pyrophosphate).

In a preferred embodiment, the buffer used is at least one carbonate and/or bicarbonate salt, such as sodium bicarbonate.

The polymerization temperature in the emulsion polymerization of graft copolymer B in step a), i.e. a2) and a3), of the process of the invention is generally 25 to 95° C., preferably 40 to 90° C., more preferably 50 to 80° C., especially 55 to 70° C.

Conventional heat treatment, for example in an isothermal manner, may be used here; however, the graft polymerization reaction is preferably conducted such that the temperature difference between the beginning and end of the reaction is at least 2° C., preferably at least 3° C., often 2 to 3° C. (i.e. the temperature at the end of the reaction is correspondingly higher).

According to the invention, graft copolymer B is produced by emulsion polymerization. The person skilled in the art will know of familiar embodiments of the emulsion polymerization reaction in batchwise operation or in continuous operation.

Optional step a2) comprises the production of a first graft shell B2 or B2′ by:
a2-1) adding and emulsion polymerizing a first portion of the at least one monomer B21 or B21′, preferably styrene, to graft base B1, giving a latex having a graft base B1 grafted with B2′, and
a2-2) further polymerizing the latex obtained in a2-1).

The temperature in step a2) is chosen as described above and is preferably 50 to 80° C., especially 55 to 70° C.

The further polymerization in step a2-2) is preferably effected over a period of 15 to 45 minutes, preferably 20 to 35 minutes.

Step a3) of the process of the invention comprises the production of a first graft shell B2 or—if steps a2-1) and a2-2) are conducted—the production of a second graft shell B2 or B2″ as described above.

The temperature in step a3) is chosen as described above and is preferably 50 to 80° C., especially 50 to 70° C. The temperature in step a3) is preferably at least 2° C., preferably 3 to 4° C., higher than the temperature in step a2).

In step a3-1), monomers B21 or B21″ and B22 or B22″ are added individually or as a monomer mixture in the amounts and ratios specified in a continuous manner to the latex from step a1) or a2-2) and polymerized.

The monomers are preferably added over a period of 60 to 250 minutes, more preferably 100 to 200 minutes, most preferably 120 to 180 minutes.

In step a3-2), the remaining portion of the at least one monomer B21 or B21″, preferably styrene, is added generally over a period of 5 to 45 minutes, preferably 10 to 35 minutes, more preferably 15 to 35 minutes, especially 20 to 30 minutes.

In step a3-2), the “remaining portion” of the at least one monomer B21 or B21″ generally means up to 5% by weight, preferably 1% to 4.5% by weight, based on graft copolymer B.

In step a3-3), the latex of graft copolymer B obtained in step 3-2) is further polymerized preferably for at least 15 minutes, more preferably for 20 to 90 minutes, most preferably 30 to 60 minutes.

The process of the invention may further comprise steps b) to g) as described above. Preference is given to a process of the invention as described above, comprising steps a), b), c) and e), and optionally steps d), f) and/or g).

### Step b) Precipitation of the Latex of Graft Copolymer B

Step b) of the process of the invention comprises precipitation of graft copolymer B obtained in step a) by mixing the latex of graft copolymer B with at least one precipitation solution PS to form a precipitation mixture, where the at least one precipitation solution PS preferably contains at least one salt and/or acid. In particular, the precipitation solution PS contains at least one alkaline earth metal salt, preferably at least one salt of magnesium and/or calcium; more preferably at least one magnesium salt.

In particular, the at least one alkaline earth metal salt is selected from alkaline earth metal halides such as chlorides, alkaline earth metal sulfates, alkaline earth metal phosphates such as orthophosphates or pyrophosphates, alkaline earth metal acetates and alkaline earth metal formates. The at least one alkaline earth metal salt is preferably selected from chlorides and sulfates.

Preferred alkaline earth metal salts here are magnesium sulfate (such as kieserite (Mg[SO4]·H₂O), pentahydrite (Mg[SO₄]·5H₂O), hexahydrite (Mg[SO₄]·6H₂O) and epsomite (Mg[SO₄]·7H₂O, bitter salt), magnesium chloride, calcium chloride, calcium formate, magnesium formate or mixtures thereof. Particular preference is given to the use of magnesium sulfate.

In particular, the solids content of the precipitation mixture obtained in step b) is in the range from 5% to 20% by weight, preferably 7% to 18% by weight, more preferably 10% to 18% by weight, also preferably 12% to 20% by weight.

Preferably, the pH of the precipitation mixture obtained in step b) is in the range from 5 to 10, preferably in the range from 6 to 9, more preferably 8 to 9. For example, the pH can be adjusted by addition of buffer salts, acids and/or bases, for example using sulfuric acid, phosphoric acid, solutions of sodium hydroxide, potassium hydroxide, sodium salts and potassium salts of carbonates (e.g. sodium carbonate Na₂CO₃ and/or sodium hydrogencarbonate NaHCO₃ or mixtures thereof), sulfates or phosphates (e.g. tetrasodium pyrophosphate).

For example, preference is given to adding at least one buffer salt selected from sodium salts, especially selected from sodium carbonates, sodium sulfates and sodium phosphates, preferably selected from sodium carbonate Na₂CO₃ and sodium hydrogencarbonate NaHCO₃.

The buffer salts, acids and/or bases can be added during steps a) and/or b), preferably during the production of the at least one graft copolymer B (emulsion polymerization, step a).

Typically, in step b), the precipitation solution PS and the graft copolymer B latex are mixed over a period in the range from 5 to 40 minutes, preferably 5 to 35 minutes.

The precipitation in step b) is conducted at a temperature (=T1) of 30 to 95° C., preferably 40 to 90° C., more preferably 50 to 90° C., most preferably 60 to 88° C. Preferably, the latex of graft copolymer B is mixed with the at least one precipitation solution PS at a temperature (=T1) of 30 to 95° C., preferably 40 to 90° C., more preferably 50 to 90° C. The precipitation is preferably effected in a precipitation vessel (e.g. precipitation tank).

### Step c) Sintering of the Precipitation Mixture

In step c) of the process of the invention, the precipitation mixture obtained in step b) is sintered at a temperature (=T2) of 85 to 150° C., preferably 90 to 145° C., especially 90 to 140° C., most preferably 92 to 135° C.

The temperature (=T2) in step c) is generally at least 5° C., preferably at least 10° C., more preferably 15° C., higher than the temperature (=T1) in step b).

During the sintering, the precipitation mixture is generally kept at that temperature T2 for at least 15 minutes, preferably for a period of 15 to 90 minutes, more preferably 15 to 75 minutes, most preferably 20 to 60 minutes.

The sintering results in the agglomeration of the graft copolymer particles present in the precipitation mixture, such that larger particles are obtained.

The precipitation in step b) and the sintering in step c) of the process of the invention can be conducted in different vessels or in the same vessel, where precipitation and sintering in the same vessel is possible especially when the process is being conducted batchwise, since, in this case, initial mixing at relatively low temperature of the graft copolymer latex with the precipitation solution is followed by sintering of the graft copolymer particles at higher temperature. It is therefore preferable when a precipitation vessel is used for step (b) and a sintering vessel for step (c), where the sintering vessel and the precipitation vessel are two different vessels.

Step d)—Cooling of the Sintered Precipitation Mixture

It has been found to be advantageous, prior to the mechanical dewatering in step e), to allow the sintered precipitation mixture obtained in step c) of the process of the invention to cool (optional step d)), preferably to a temperature of 20 to 90° C., often 20 to 80° C., and often 20 to 70° C. The sintered precipitation mixture can be cooled using a heat exchanger, for example.

Step e)—Mechanical Dewatering of the Sintered Precipitation Mixture

In step e) of the process of the invention, mechanical dewatering of the sintered precipitation mixture obtained in step c) or d) is conducted to obtain a graft copolymer B having a water content of not more than 50% by weight, preferably not more than 40% by weight, more preferably 10% to 35% by weight.

The water content (also referred to as residual moisture content) of graft copolymer B after dewatering is the water content in percent by weight, based on the moist graft copolymer B obtained after dewatering.

The water content is especially determined with the aid of suitable analytical devices (e.g. drying and weighing equipment), with drying of the sample until a constant weight of the sample is achieved over a defined period of time.

For example, the water content of the graft copolymer B can be determined in a Halogen Moisture Analyzer HR73 from Mettler Toledo at 180° C. until a constant weight has been attained for 30 seconds.

In particular, the water content of the dewatered graft copolymer B obtained in step e) is in the range from 10% to 50% by weight, preferably 10% to 40% by weight, more preferably 10% to 35% by weight (based on the entirety of the dewatered graft copolymer B).

Typically, step e) of the process of the invention comprises mechanical dewatering of the sintered graft copolymer B by continuous or batchwise centrifugation and/or filtration.

Mechanical dewatering of the sintered graft copolymer B is preferably achieved by continuous centrifugation.

The sintered graft copolymer B is typically centrifuged at a centripetal acceleration of 200 to 2200 g (where g is the acceleration due to gravity (1 g=9.81 m/s)), preferably of 500 to 1500 g, for a period of 1 second to 5 minutes, preferably 1 to 120 seconds.

Step f)—Optional Washing of the Dewatered Graft Copolymer B

The mechanical dewatering of graft copolymer B in step e) can be combined with a wash step (for example on a centrifuge), or may be followed by a wash step (step f)), wherein the dewatered graft copolymer B is preferably treated with water.

It is additionally possible to use a mixture of water and a polar, water-miscible organic solvent, such as alcohols.

Preferably, the water or the aforementioned water mixture is removed after treatment of graft copolymer B by filtration and/or centrifugation.

Preferably, in a downstream wash step f), a graft copolymer B having a water content in the range from 10% to 50% by weight, preferably 10% to 40% by weight, more preferably 10% to 35% by weight, is obtained.

It is also preferable that a graft copolymer B having a water content as described above for step e) is obtained.

Step g)—Optional Drying of the Dewatered Graft Copolymer B

The process of the invention also optionally comprises drying (step g) of the—dewatered and optionally washed—graft copolymer B obtained in step e) or f) in a known manner.

For example, the dewatered and optionally washed graft copolymer B can be dried by hot drying gas, for example air, or by means of a pneumatic dryer. The drying can be conducted, for example, in a drying cabinet or other commonly known drying apparatuses, such as flow dryers or fluidized bed dryers. Typically, the optional drying step is conducted at a temperature of the drying apparatus or of the drying gas in the range from 50 to 180° C., preferably from 55 to 155° C., more preferably from 60 to 150° C.

Typically, the resultant dried graft copolymer B has a water content below 5% by weight, preferably below 1% by weight, preferably in the range from 0.05% to 0.8% by weight, preferably 0.1% to 0.8% by weight.

The invention further provides a graft copolymer B obtained by the process of the invention. Graft copolymers B obtained by the process of the invention are notable—by comparison with noninventive graft copolymers (without step a3-2, i.e. without B21 further metered addition)—for a white or virtually white color even after the sintering step, and have a low, distinctly reduced yellowness index (measured to ASTM E313-10).

The invention further provides a process for producing a thermoplastic molding compound, comprising at least one graft copolymer B obtained by the process of the invention, and at least one thermoplastic vinylaromatic copolymer A, optionally at least one further polymeric component C selected from polycarbonates, polyamides and polyesters, and optionally one or more additives and/or auxiliaries D, by mixing the components, preferably in the melt.

The at least one thermoplastic vinylaromatic copolymer A is preferably a rubber-free polymer.

The at least one thermoplastic vinylaromatic copolymer A is preferably a copolymer produced from:
A1: 50% to 95% by weight, preferably 60% to 90% by weight, more preferably 60% to 85% by weight, based on copolymer A, of a monomer A1 selected from styrene, alpha-methylstyrene and mixtures of styrene and at least one further monomer selected from o-methylstyrene, p-methylstyrene, and C₁-C₈-alkyl (meth)acrylate;
A2: 5% to 50% by weight, preferably 10% to 40% by weight, more preferably 15% to 40% by weight, based on copolymer A, of at least one monomer A2 selected from acrylonitrile and mixtures of acrylonitrile and at least one other monomer selected from methacrylonitrile, acrylamide, vinyl methyl ether, anhydrides of unsaturated carboxylic acids (e.g. maleic anhydride or phthalic anhydride) and imides of unsaturated carboxylic acids (e.g. N-substituted maleimides such as N-cyclohexylmaleimide or N-phenylmaleimide).

The thermoplastic copolymer A is preferably produced from mixtures of styrene with other comonomers A2. More preferably, A1 is styrene and A2 is acrylonitrile, i.e. thermo-plastic copolymer A is a styrene-acrylonitrile copolymer (SAN).

Also more preferably, A1 is (alpha)-methylstyrene and A2 is acrylonitrile, i.e. thermoplastic copolymer A is an (alpha)-methylstyrene-acrylonitrile copolymer (AMSAN).

The thermoplastic copolymer A used in the context of the subject matter of the present invention may generally be any SAN and/or AMSAN copolymer known to the person skilled in the art.

In particular, thermoplastic copolymer A is selected from SAN and/or AMSAN copolymers containing less than 36% by weight of acrylonitrile as monomer A2, based on copolymer A. Preferably, the thermoplastic copolymer A contains the at least one vinylaromatic monomer A1, preferably styrene, in an amount of 50% to 99% by weight, preferably 60% to 95% by weight, more preferably 65% to 90% by weight, most preferably 65% to 70% by weight, and at least one (meth)acrylonitrile monomer A2, preferably acrylonitrile, in an amount of 1% to 50% by weight, preferably 5% to 40% by weight, more preferably 10% to 35% by weight, most preferably 30% to 35% by weight.

In particular, the weight-average molecular weight (Mw) of thermoplastic copolymer A is in the range from 15 000 to 200 000 g/mol, preferably in the range from 30 000 to 150 000 g/mol. Typically, the number-average molar mass (Mn) of thermoplastic copolymer A is 15 000 to 100 000 g/mol.

Preferably, average molecular weight can be determined by gel permeation chromatography (GPC) relative to polystyrene as standard and using UV detection, for example.

Preferably, the thermoplastic copolymer A has a viscosity number VN (determined to DIN 53726 at 25° C., 0.5% by weight in dimethylformamide) of 50 to 120 ml/g, preferably of 50 to 100 ml/g, more preferably of 55 to 85 ml/g.

In a preferred embodiment, thermoplastic copolymer A is a SAN (styrene-acrylonitrile copolymer) or AMSAN (alpha-methylstyrene-acrylonitrile copolymer) having an average molecular weight and/or average viscosity in the ranges mentioned above.

Copolymer A may be produced by any known methods, for example bulk polymerization, solution polymerization, suspension polymerization and emulsion polymerization or mixed methods, e.g. bulk/suspension polymerizations, with or without further components.

The synthesis of thermoplastic copolymers A is possible by thermal initiation or by addition of initiators, especially free-radical initiators, for example peroxides.

Preferably, thermoplastic copolymers A are produced by bulk or solution polymerization.

More preferably, the thermoplastic copolymer A is produced from the acrylonitrile and styrene and/or alpha-methylstyrene components by bulk polymerization or in the presence of one or more solvents, for example toluene or ethylbenzene.

A polymerization method is described, for example, in Kunststoff-Handbuch [Plastics Handbook], Vieweg-Daumiller, volume V, (Polystyrol [Polystyrene]), Carl-Hanser-Verlag, Munich 1969, pages 122 ff.

Optionally, the thermoplastic molding compound contains 0% to 90% by weight, preferably 0% to 60% by weight, often 0% to 30% by weight, based on the overall molding compound, of at least one further polymer component C. Preferably, optional polymer component C is selected from polycarbonates (including aromatic polycarbonates and aromatic polyestercarbonates), polyamides and polyesters, more preferably from polycarbonates and polyamides.

Preferably, the at least one further polymer component C is at least one aromatic polycarbonate and/or at least one aromatic polyestercarbonate.

Suitable aromatic polycarbonates and/or aromatic polyestercarbonates are described in the prior art and can be produced by known methods. Particularly suitable aromatic polycarbonates and aromatic polyestercarbonates and the production thereof are described in DE-A 2 714 544, DE-A 3 000 610, DE-A 3 832 396 and DE-A 3 077 934.

The aromatic polycarbonate used as component C is preferably a polycarbonate based on bisphenol A and phosgene, which also includes polycarbonates that have been produced from corresponding precursors or synthesis units of bisphenol A and phosgene.

Likewise preferably, the at least one further polymer component C may be at least one polyamide selected from homopolyamides, copolyamides and mixtures of such polyamides. Suitable polyamides and processes for production thereof are known from the prior art. Particularly suitable semicrystalline polyamides are nylon-6, nylon-6,6, mixtures and corresponding copolymers of these components.

In particular, the thermoplastic molding compound obtained by the process of the invention may contain 0% to 10% by weight, preferably 0% to 5% by weight, often 0.1% to 5% by weight, based on the overall thermoplastic molding compound, of at least one additive and/or auxiliary D.

More preferably, the at least one additive and/or auxiliary D is present in an amount of 0.001% to 10% by weight, more preferably 0.01% to 5% by weight, based on the overall thermoplastic molding compound.

In particular, the additive and/or auxiliary D is not a polymeric compound.

The optional additive and/or auxiliary D may be selected from commonly known additives and/or auxiliaries for polymer materials. For customary auxiliaries and additives, reference is made by way of example to “Plastics Additives Handbook”, eds. Gächter and Müller, 4th edition, Hanser Verlag, Munich, 1996. For example, the at least one additive and/or auxiliary D may be selected from fillers, reinforcers, dyes, pigments, lubricants or demolding agents, stabilizers, especially light and heat stabilizers, antioxidants, UV absorbers, plasticizers, antistats, flame retardants, bactericides, fungicides, optical brighteners and blowing agents.

The optional additive and/or auxiliary D is preferably selected from dyes, pigments, lubricants or demolding agents, stabilizers, especially light stabilizers, antistats, flame retardants and fillers, especially mineral fillers.

The invention is preferably directed to a process for producing a thermoplastic molding compound comprising (preferably consisting of):
A: 5% to 95% by weight, preferably 30% to 95% by weight, more preferably 40% to 90% by weight, of at least one thermoplastic copolymer A produced from:
   A1: 50% to 95% by weight, preferably 60% to 90% by weight, more preferably 60% to 85% by weight, based on copolymer A, of a monomer A1 selected from styrene, alpha-methylstyrene and mixtures of styrene and at least one further monomer selected from o-methylstyrene, p-methylstyrene, and C₁-C₈-alkyl (meth)acrylate;
   A2: 5% to 50% by weight, preferably 10% to 40% by weight, more preferably 15% to 40% by weight, based on copolymer A, of at least one monomer A2 selected from acrylonitrile and mixtures of acrylonitrile and at least one other monomer selected from methacrylonitrile, acrylamide, vinyl methyl ether, anhydrides of unsaturated carboxylic acids (e.g. maleic anhydride or phthalic anhydride) and imides of unsaturated carboxylic acids (e.g. N-substituted maleimides such as N-cyclohexylmaleimide or N-phenylmaleimide).
B: 5% to 95% by weight, preferably 5% to 70% by weight, more preferably 10% to 60% by weight, of at least one graft copolymer B as defined above;
C: 0% to 90% by weight, preferably 0% to 80% by weight, often 0% to 30% by weight, of at least one further polymeric component C, and
D: 0% to 10% by weight, preferably 0% to 5% by weight, frequently 0.1% to 5% by weight, of at least one additive and/or auxiliary D; and
   wherein the process comprises the following steps: a), preferably a), b), c), e) and optionally d), f) and/or g) as described above, and
   h) mixing thermoplastic copolymer A and the at least one graft copolymer B, and optionally at least one further polymeric component C and/or optionally at least one additive and/or auxiliary D.

Processes and apparatuses for mixing of graft copolymer B with thermoplastic polymer A and optionally the further polymer component C and/or additive and/or auxiliary D are known to those skilled in the art.

Possible mixing apparatuses for performance of compounding are, for example, batchwise heated internal mixers with or without plungers, continuous kneaders such as continuous internal mixers, screw kneaders with axially oscillating screws, Banbury mixers, continuous extruders and roll mills, mixing systems with heated rolls and calenders. Typically, mixing step h) comprises melt compounding and/or melt extrusion and can typically be conducted using one or more kneaders, extruders and/or twin-shaft screws. For example, single- or twin-screw extruders are particularly suitable for melt extrusion. Preference is given to the use of a twin-screw extruder.

Mixing in step h) can be effected successively or simultaneously.

In addition, it is suitable to mix some or all components at a temperature of 15 to 40° C., for example at room temperature, in a first step and then—in a second step—to increase the temperature to 200 to 300° C., optionally with addition of further components.

Preferably, the mixing in step h) is conducted at temperatures in the range from 100 to 400° C., preferably 180 to 300° C. Typically, this temperature depends on the chemical and physical properties of the components.

Typically, it should be selected such that an essentially molten polymer mixture is achieved. The term “molten” in this context means that all components, especially the polymeric components, have melted, except for those that are not supposed to be melted, for example glass fibers or pigment particles. On the other hand, the temperature should not be unnecessarily high, in order to avoid thermal damage to the polymer mixture. The mixing apparatus is typically operated at temperatures of 150 to 400° C., preferably 180 to 300° C., and typically has different temperature zones, as known to the person skilled in the art.

The mixing of thermoplastic copolymer A, the at least one graft copolymer B and any further components C and D can be effected successively or simultaneously in a known manner. In addition, it is possible first to mix some components at temperatures of 15 to 40° C., especially at room temperature (about 20° C.), and then to increase the temperature to 200 to 300° C., optionally with addition of other components.

The invention further relates to a thermoplastic molding compound and to shaped bodies produced therefrom, wherein the thermoplastic molding compound is obtained by the process of the invention for production of a thermoplastic molding compound containing graft copolymer B as described, and at least one thermoplastic vinylaromatic copolymer A.

The thermoplastic molding compounds may be used for production of shaped bodies such as sheets or semifinished products, films, fibers or else foams, and the corresponding shaped bodies such as sheets, semifinished products, films, fibers or foams. Processing can be effected by the known thermoplastic processing methods; in particular, production can be effected by thermoforming, extrusion, injection molding, calendering, blowmolding, pressing, pressure sintering, or sintering, preferably by injection molding.

The molding compounds of the invention can be used for production of shaped bodies of any kind. These can be produced via injection molding, extrusion and blowmolding methods. Another form of processing is production of shaped articles by thermoforming from previously produced sheets or films, and the film overmolding method.

Examples of these shaped articles are films, profiles, housing parts of any kind, for example for domestic appliances such as juice presses, coffee machines, mixers; for office equipment such as monitors, printers, copiers; exterior and interior parts of motor vehicles; sheets, tubes, electrical installation ducts, windows, doors and other profiles for the construction sector (interior fitout and exterior applications), and parts for electrical and electronic applications, such as switches, plugs and sockets.

In particular, the molding compounds of the invention can be used, for example, for production of the following shaped bodies: parts for the interior trim of rail vehicles, ships, aircraft, buses and other motor vehicles, bodywork parts for motorized vehicles, housings for electrical devices having small transformers, housings for devices for processing and transmission of information, housings and linings for medical devices, massage devices and housings therefor, toy vehicles for children, two-dimensional wall elements, shaped housing parts for safety devices, thermally insulated transport vessels, apparatuses for keeping or care of small animals, shaped articles for sanitary and bathing equipment, protective grilles for ventilation openings, shaped articles for garden sheds and tool sheds, housings for garden tools.

The invention is described in detail by the examples and claims that follow. “Parts” hereinafter means parts by weight, unless stated otherwise.

### EXAMPLES

### Example 1 (Inventive, Further Metered Addition of Styrene (Incl. Step a3-2)

### Production of Styrene-Co-Acrylonitrile-Grafted Polybutylacrylate Latices (Graft Copolymer B-1)

The following graft copolymer B latex was produced as follows:

### Seed Latex BS

The reaction vessel was charged with 132 parts demineralized water, 1.0 part of the sodium salt of a C₁₂-C₁₈-alkylsulfonic acid and 0.41 part sodium bicarbonate. Once the temperature in the reaction vessel had reached 59° C., 0.30 part potassium persulfate dissolved in 9.7 parts demineralized water was added.

A mixture of 98 parts butyl acrylate and 2 parts tricyclodecenyl acrylate was added thereto within 210 minutes, and polymerized. Thereafter, polymerization was continued for a further 60 minutes.

The resultant polymer dispersion had a total solids content of 38.8%, and the latex particles had an average particle diameter Dv (volume average (determined by light scattering (LS) by means of Beckman Coulter)) of 87 nm.

### Graft Base B1-1

The reaction vessel was charged with 60.1 parts demineralized water, 0.3 part of the above-described seed latex (particle diameter 87 nm) and 0.21 part sodium hydrogen-carbonate.

After the reaction vessel had been heated to 61° C., 0.18 part potassium persulfate dissolved in 5.8 parts demineralized water was added to the reaction mixture. A mixture of 58.9 parts butyl acrylate and 1.1 parts tricyclodecenyl acrylate was added thereto within 210 minutes, and polymerized.

Parallel to the first feed, a solution of 0.38 part of the sodium salt of a C₁₂-C₁₈-alkylsulfonic acid in 21.9 parts demineralized water was added over a period of 210 minutes. Thereafter, the reaction was continued at 61° C. for 60 minutes.

The resultant polymer dispersion (butyl acrylate rubber latex, graft base B1-1) had a total solids content of 39.3%, and the average particle diameter Dv (determined by LS Beckman Coulter) of the latex particles was 440 nm.

### (a) Production of Graft Shell B2 (2-Stage B2′ and B2″)

The reaction vessel was charged with 180 parts by weight of demineralized water, 59.9 parts by weight of graft base B1-1 and 0.11 part by weight of the sodium salt of a C₁₂-C₁₈ paraffinsulfonic acid. After the reaction vessel had been heated to 61° C., 0.16 part by weight of potassium persulfate dissolved in 5.2 parts by weight of demineralized water was added to the reaction mixture. 8.67 parts by weight of styrene was added at a temperature of 61° C. within 60 minutes, followed by a further polymerization time of 30 minutes at 61° C. Thereafter, a mixture of 18.9 parts by weight of styrene and 8.10 parts by weight of acrylonitrile was added over a period of 150 min, with a continuous increase in the temperature to 65° C. during this period. Thereafter, 4.33 parts by weight of styrene was added over a period of 30 minutes. The reaction was continued at 65° C. for a further 60 minutes. A dispersion of a graft copolymer B-1 was obtained.

The latex particles B-1 had an average diameter Dv of 556 nm (determined by LS Beckman Coulter). An aliquot was taken in order to determine the residual acrylonitrile (AN) monomer content directly after the further polymerization time at 65° C.

### b) Precipitation of Graft Copolymer B Latex

110 g of an MgSO4 solution (20.3% by weight) was mixed with 1850 g of demineralized water. 390 g of that solution was used as preliminary charge and heated to 70° C. 800 g of the polymer latex from step a2) and the remaining dilute MgSO₄ solution were added separately within 10 minutes, while the temperature is kept at 70° C.

### c) Sintering of the Precipitation Mixture and d) Cooling

The precipitation mixture obtained in step b) was heated to a temperature of 124° C. within 30 minutes (sintering) and, on attainment of a temperature of 124° C., the heating was stopped and the precipitation mixture was allowed to cool to room temperature.

### e) Dewatering, f) Washing and g) Drying

The resultant (sintered and cooled) precipitation mixture was centrifuged. The dewatered, washed graft copolymer B was dried in a laboratory oven at 70° C. for 2 days, and a powder of graft copolymer B was obtained. The dried graft copolymer B had a water content of <1% by weight.

### Comparative Example C1

Production of a graft copolymer B-C1 (without further metered addition of styrene) A graft copolymer B having a 2-stage graft shell B2′ and B2″ was produced analogously to example 1, except that there was no further metered addition of styrene in step a), i.e. there is no step a3-2). The reaction vessel was charged with 180 parts by weight of demineralized water, 59.9 parts by weight of graft base B1-1 and 0.11 part by weight of the sodium salt of a C₁₂-C₁₈ paraffinsulfonic acid. After the reaction vessel had been heated to 61° C., 0.16 part by weight of potassium persulfate dissolved in 5.2 parts by weight of demineralized water was added to the reaction mixture. 13.0 parts by weight of styrene was added at a temperature of 61° C. within 60 minutes, followed by a further polymerization time of 30 minutes at 61° C. Then a mixture of 18.9 parts by weight of styrene and 8.10 parts by weight of acrylonitrile was added over a period of 150 minutes, with a continuous increase in the temperature to 65° C. during this period. The reaction was continued at 65° C. for a further 60 minutes. A dispersion of a graft copolymer B-C1 was obtained. The latex particles B-C1 had an average diameter of 558 nm (determined by LS Beckman Coulter). An aliquot was taken in order to determine the residual AN monomer content directly after the further polymerization time at 65° C. The remaining steps b) to g) were conducted analogously to example 1.

### Comparative Example C2

Production of a graft copolymer B-C2 (comparison, further metered addition of MMA) A graft copolymer B having a 2-stage graft shell B2′ and B2″ was produced analogously to example 1, except that there was further metered addition in step a3-2) of methyl methacrylate (MMA) rather than styrene.

The reaction vessel was charged with 180 parts by weight of demineralized water, 59.9 parts by weight of graft base B1-1 and 0.11 part by weight of the sodium salt of a C₁₂-C₁₈ paraffinsulfonic acid. After the reaction vessel had been heated to 61° C., 0.16 part by weight of potassium persulfate dissolved in 5.2 parts by weight of demineralized water was added to the reaction mixture. 8.67 parts by weight of styrene was added at a temperature of 61° C. within 60 minutes, followed by a further polymerization time of 30 minutes at 61° C. Thereafter, a mixture of 18.9 parts by weight of styrene and 8.10 parts by weight of acrylonitrile was added over a period of 150 min, with a continuous increase in the temperature to 65° C. during this period. Thereafter, 4.33 parts by weight of methyl methacrylate was added over a period of 30 minutes. The reaction was continued at 65° C. for a further 60 minutes.

A dispersion of a graft copolymer B-C2 was obtained. The latex particles B-C2 had an average diameter of 554 nm (determined by LS Beckman Coulter). An aliquot was taken in order to determine the residual AN monomer content directly after the further polymerization time at 65° C.

The remaining steps b) to g) were conducted analogously to example 1.

The residual acrylonitrile (AN) monomer (REMO) content (see table 1) was ascertained by headspace gas chromatography with a flame ionization detector (GC-FID) with external calibration using mesitylene and propionitrile as internal standard (=IS) solution in DMSO.

For this purpose, 1.00 g of latex dispersion B1, B-C1 or B-C2 was admixed with about 5.00 g of IS solution. The resultant mixture was shaken, and the REMO AN content was measured by headspace GC-FID.

REMO-AN after 300 minutes based on

tsc [ppm]=m(AN)/m(latex)×tsc/100×1000000
m (AN): mass of AN in the latex sample, calculated by internal calibration with mesitylene and propionitrile
m (latex): total amount of the latex used for the analysis
tsc: total solids content

Yellowness index (YI) was ascertained to ASTM E313-10 for the resultant graft copolymers B1, B-C1 and B-C2 (see table 1). For this purpose, the respective graft copolymer powder was fixed between 2 microscope slides.

TABLE 1

| Graft copolymer | B-C1 | B-1 | B-C2 |
|---|---|---|---|
| Reaction | without | further metered | further metered |
| | further metered | addition | addition |
| | addition | of styrene | of MMA |
| YI (powder) after sintering | 3.29 | 1.89 | 2.35 |
| tsc (%) after 300 min | 34.34 | 34.30 | 34.06 |
| REMO AN [ppm] after 300 min | 6049 | 2564 | 5217 |

The examples (see table 1) show that the residual acrylonitrile monomer content (REMO AN) of graft copolymer B-1 obtained by the process of the invention is very much lower than the REMO AN content of comparative examples B-C1 and B-C2.

In addition, there is a distinct decrease in yellowness index (YI) of the graft copolymer powder (see example of graft copolymer B-1) when, in the process of the invention, a portion of the styrene used for production of the graft shell is metered in only after the styrene-acrylonitrile mixture has been added.

This is particularly surprising since no such strongly pronounced effect is found in the case of further metered addition of MMA (see comparative example B-C2).

The higher the yellowness index of a polymeric material, the more difficult it is to color the material in a particular color.

The graft copolymers of the invention, or molding compounds comprising them, have a light, often white or virtually white, base color, which means that they can be efficiently colored in a broad color spectrum and used in various ways.

Various ASA copolymers were produced by the process of the invention and tested; they had improved color properties.

Also produced and tested were shaped articles made from the ASA copolymers from processes of the invention; they had improved color properties inter alia.

1-17. (canceled)

18. A process for producing at least one graft copolymer B comprising:
B1: 40% to 90% by weight, based on graft copolymer B, of at least one graft base B1, obtained by emulsion polymerization of:
B11 50% to 100% by weight, based on graft base B1, of at least one monomer B11 selected from the group consisting of C₁-C₈ alkyl (meth)acrylate and butadiene;
B12 0% to 10% by weight, based on graft base B1, of at least one polyfunctional crosslinking monomer B12; and
B13 0% to 50% by weight, based on graft base B1, of at least one further monomer B13 selected from the group consisting of styrene, alpha-methylstyrene, C₁-C₄-alkylstyrene, acrylonitrile, methacrylonitrile, isoprene, chloroprene, methyl methacrylate, alkylene glycol di(meth)acrylate, and vinyl methyl ether;
wherein the sum total of B11, B12, and B13 is 100% by weight; and
B2: 10% to 60% by weight, based on graft copolymer B, of at least one graft shell B2 obtained—in the presence of the at least one graft base B1—by emulsion polymerization of:
B21 50% to 100% by weight, based on graft shell B2, of at least one vinylaromatic monomer B21 selected from the group consisting of styrene and alpha-methylstyrene; and
B22 0% to 50% by weight, based on graft shell B2, of at least one monomer B22 selected from acrylonitrile or mixtures of acrylonitrile and at least one further monomer selected from the group consisting of methacrylonitrile, acrylamide, vinyl methyl ether, anhydrides of unsaturated carboxylic acids, and imides of unsaturated carboxylic acids;
wherein the sum total of B21 and B22 is 100% by weight; and
wherein at least one graft shell B2 is obtained by emulsion polymerization of 50% to 95% by weight of at least one vinylaromatic monomer B21 and 5% to 50% by weight of at least one monomer B22;
wherein the sum total of the at least one graft base B1 and the at least one graft shell B2 is 100% by weight; and
wherein the process comprises the following steps:
a) producing a latex of at least one graft copolymer B, comprising:
a1) initially charging an aqueous latex comprising at least one graft base B1;
a2) optionally producing a first graft shell B2 or B2′ by:
a2-1) adding and emulsion polymerizing a first portion of the at least one vinylaromatic monomer B21 or B21′, to graft base B1;
a2-2) further polymerizing the latex obtained in a2-1);
a3) producing a first graft shell B2 or, if steps a2-1) and a2-2 are conducted, producing a second graft shell B2 or B2″ by:
a3-1) simultaneously adding and emulsion polymerizing a first or a further portion of the at least one vinylaromatic monomer B21 or B21″ and the total amount of the at least one monomer B22 or B22″ to the latex from step a1) or a2-2);
a3-2) immediately after the addition of the monomers in step a3-1) has ended, adding and emulsion polymerizing the residual portion of the at least one vinylaromatic monomer B21 or B21″ to the latex obtained in step a3-1); and
a3-3) further polymerizing the latex of graft copolymer B obtained in step a3-2).

19. The process as claimed in claim 18, further comprising the following steps b) to g):
b) precipitating the graft copolymer B latex obtained in step a) at a temperature of 30 to 95° C. by mixing the graft copolymer B latex with at least one precipitation solution PS to form a precipitation mixture;
c) sintering the precipitation mixture obtained in step b) at a temperature of 85 to 150° C., for 15 to 90 minutes,
wherein the temperature in step c) is at least 5° C. higher than in step b);
d) optionally cooling the sintered precipitation mixture from step c), to a temperature of 20 to 90° C.;
e) mechanically dewatering the sintered precipitation mixture obtained in step c) or d) to obtain a graft copolymer B having a water content of not more than 50% by weight;
f) optionally washing graft copolymer B obtained in step e); and
g) optionally drying graft copolymer B obtained in step e) or f).

20. The process as claimed in claim 18, wherein the at least one graft base B1 is obtained by emulsion polymerization of:
B11: 80% to 99.9% by weight, based on graft base B1, of at least one C₁-C₈-alkyl (meth)acrylate as monomer B11;
B12:0.1% to 10% by weight, based on graft base B1, of at least one polyfunctional crosslinking monomer B12; and
B13: 0% to 19.9% by weight, based on graft base B1, of at least one further monomer B13 selected from the group consisting of styrene, alpha-methylstyrene, C₁-C₄-alkylstyrene, acrylonitrile, methacrylonitrile, isoprene, chloroprene, methyl methacrylate, alkylene glycol di(meth)acrylate, and vinyl methyl ether;
wherein the sum total of B11, B12, and B13 is 100% by weight.

21. The process as claimed in claim 18, wherein the at least one graft copolymer B comprises:
B1: 50% to 70% by weight, based on graft copolymer B, of exactly one graft base B1; and
B2: 30% to 50% by weight, based on graft copolymer B, of exactly one graft shell B2 obtained by emulsion polymerization—in the presence of graft base B1—of:
B21: 50% to 95% by weight, based on graft shell B2, of at least one vinylaromatic monomer B21 selected from the group consisting of styrene and (alpha)-methylstyrene; and
B22: 5% to 50% by weight, based on graft shell B2, of at least one monomer B22 selected from acrylonitrile or mixtures of acrylonitrile and methacrylonitrile;
wherein the sum total of graft base B1 and graft shell B2 is 100% by weight, and wherein the latex of graft copolymer B obtained in step a) has a particle size in the range from 60 to 200 nm.

22. The process as claimed in claim 18, wherein graft copolymer B comprises:
B1: 50% to 70% by weight, based on graft copolymer B, of at least one graft base B1; and
B2′: 5% to 25% by weight, based on graft copolymer B, of at least one graft shell B2′ obtained by emulsion polymerization—in the presence of graft base B1—of:
B21′: 100% by weight, based on graft shell B2′, of at least one vinylaromatic monomer B21 selected from the group consisting of styrene and (alpha)-methylstyrene; and
B2″: 20% to 40% by weight, based on graft copolymer B, of at least one graft shell B2″ obtained by emulsion polymerization—in the presence of graft base B1 grafted with B2′—of:
B21″: 65% to 90% by weight, based on graft shell B2″, of at least one vinylaromatic monomer B21″ selected from the group consisting of styrene and (alpha)-methylstyrene; and
B22″: 10% to 35% by weight, based on graft shell B2″, of at least one monomer B22″ selected from acrylonitrile or mixtures of acrylonitrile and methacrylonitrile;
wherein the sum total of graft base B1, graft shell B2′ and graft shell B2″ is 100% by weight, and wherein the latex of graft copolymer B obtained in step a) has a particle size in the range from 300 to 800 nm.

23. The process as claimed in claim 18, wherein vinylaromatic monomer B21 or B21′ and B21″ is styrene, and monomer B22 or B22″ is acrylonitrile.

24. The process as claimed in claim 18, wherein, in step a3-2), the remaining portion of the at least one vinylaromatic monomer B21 or B21″ is generally added over a period of 5 to 45 minutes.

25. The process as claimed in claim 18, wherein, in step a3-3), the latex of graft copolymer B obtained in step a3-2) is further polymerized for at least 15 minutes.

26. The process as claimed in claim 18, wherein, in step a3-2), the residual portion of the at least one vinylaromatic monomer B21 or B21″ is up to 5% by weight, based on graft copolymer B.

27. The process as claimed in claim 18, wherein step a2) is conducted and, in step a3), a second graft shell B2″ is produced.

28. The process as claimed in claim 18, wherein, in step a3), the temperature is 40 to 90° cand is at least 2° C. higher than the temperature in step a2).

29. The process as claimed in claim 18, wherein, in step b), the graft copolymer B latex is precipitated at a temperature of 40 to 90° C.

30. The process as claimed in claim 19, wherein, in step c), the precipitation mixture is sintered at a temperature of 90 to 145° C., for 15 to 90 minutes.

31. A graft copolymer B obtained by a process as claimed in claim 18.

32. A process for producing a thermoplastic molding compound-comprising at least one graft copolymer B as claimed in claim 31 and at least one, thermoplastic vinylaromatic copolymer A, optionally at least one further polymeric component C selected from the group consisting of polycarbonates, polyamides, and polyesters, and optionally one or more additives and/or auxiliaries D—by mixing the components.

33. A thermoplastic molding compound obtained by a process as claimed in claim 32.

34. A shaped article made from a thermoplastic molding compound as claimed in claim 33.

35. The process as claimed in claim 18 wherein:
the at least one polyfunctional crosslinking monomer B12 is selected from the group consisting of allyl (meth)acrylate, divinylbenzene, diallyl maleate, diallyl fumarate, diallyl phthalate, triallyl cyanurate, triallyl isocyanurate, and dihydrodicyclopentadienyl acrylate (DCPA).

36. The process as claimed in claim 18, wherein, in step a3-2, the residual portion of the at least one vinylaromatic monomer B21 or B21″ is styrene.

37. The process as claimed in claim 19, wherein, in step c) the precipitation mixture is sintered at a temperature of 90 to 140° C. for 15 to 75 minutes.
